(19) United States
(12) Patent Application Publication
(10) Pub. No.: US 2018/0302933 A1
(43) Pub. Date: Oct. 18, 2018

(54) DATA LINK LAYER PROTOCOLS FOR BODY AREA NETWORK

(71) Applicant: QUALCOMM Incorporated, San Diego, CA (US)

(72) Inventors: Linhai HE, San Diego, CA (US); Stephen Jay SHELLHAMMER, Ramona, CA (US); Santosh ABRAHAM, San Diego, CA (US)

(21) Appl. No.: 15/682,152

(22) Filed: Aug. 21, 2017

Related U.S. Application Data
(60) Provisional application No. 62/486,128, filed on Apr. 17, 2017.

(51) Int. Cl. H04W 76/02; H04L 5/00

(52) U.S. Cl. CPC H04W 76/025; H04W 84/18; H04L 5/0055

(57) ABSTRACT

A leader-follower protocol is provided for wireless communication in a BAN. A connection is established between a leader of the BAN and at least one follower in the BAN. The follower refrains from transmitting until a transmission is received from the leader. The transmission from the leader triggers a transmission opportunity at the follower for a window of time. Once the follower receives a transmission from the leader, the follower may then transmit a second transmission to the leader within the window of time. The transmission from the leader that triggers the transmission opportunity for the follower may be a data transmission, a poll transmission, an ACK a sleep mode message, etc. After transmitting a transmission to the a follower, the leader refrains from transmitting for the window of time in order to accommodate the transmission opportunity for the at least one follower.

### CROSS-REFERENCE TO RELATED APPLICATION

This application claims the benefit of U.S. Provisional Application Ser. No. 62/486,128, entitled “DATA LINK LAYER PROTOCOLS FOR BODY AREA NETWORK” and filed on Apr. 17, 2017, which is expressly incorporated by reference herein in its entirety.

### BACKGROUND

### Field

The present disclosure relates generally to communication systems, and more particularly, to a link control protocol for a body area network (BAN).

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks may also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.). One example of a wireless communication network is a Body Area Network (BAN).

A BAN may involve wireless communication between multiple wearable or implanted devices. BANs may involve various different devices for different types of applications. For example, wearable or implanted devices for healthcare applications may include sensors or devices that monitor, log and transmit vital healthcare signals. Example wearable devices include a smart watch, an armband, a pedometer, a headset, hearing aids, a heart rate monitor, among others. Such devices may be low power and may require a long battery lifetime. Other mobile devices within range of the BAN may also communicate with or form a part of the BAN. For example, the BAN may include wireless devices such as a mobile telephone, a tablet, a personal digital assistant, laptop, a global positioning system, a multimedia device, a video device, a digital audio player (e.g., MP3 player), a camera, a game console, a tablet, a smart device, or any other similar functioning device that is within range of the BAN and capable of wireless communication with the other devices of the BAN. Thus, a BAN may include unique and varying characteristics along with a need for energy efficiency.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In order to address the unique needs of a BAN, a leader-follower link control protocol is provided for wireless communication at a BAN. The protocol may provide a lower-power, half duplex data link layer (DLL) protocol that supports different types of BAN applications and devices. The protocol may support both assured and best effort data. The protocol may function over different air interface technologies and may be operable both in point-to-point links and in star topology BANs.

In an aspect of the disclosure, a method, a computer-readable medium, and an apparatus are provided for wireless communication at a follower in a BAN. The apparatus establishes a connection with a leader in the BAN as a follower. The follower refrains from transmitting until a transmission is received from the leader, wherein the transmission received from the leader triggers a transmission opportunity at the follower for a window of time, e.g., according to a leader-follower protocol. The apparatus may receive the transmission from the leader and may then transmit a second transmission to the leader within the window of time. The transmission from the leader triggering the transmission opportunity for the follower may comprise any of a data transmission, a poll transmission, an acknowledgement (ACK), a sleep mode message, etc.

In another aspect of the disclosure, a method, a computer-readable medium, and an apparatus are provided for wireless communication at a leader in a BAN. The apparatus establishes a connection with at least one follower in the BAN. The apparatus transmits a transmission to the at least one follower and then refrains from transmitting for a window of time following the transmission according to a leader-follower protocol. The transmission from the leader may trigger a transmission opportunity for a follower, and the window of time corresponds to the transmission opportunity for the follower. The transmission from the leader that triggers the transmission opportunity for the follower may comprise any of a data transmission, a poll transmission, an ACK, a sleep mode message, etc.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a BAN wireless communications system.

FIG. 2 is a diagram illustrating example devices in a BAN wireless communications system.

FIG. 3 is a diagram illustrating example devices in a BAN wireless communications system.

FIG. 4 is a diagram illustrating an example communication flow in a BAN wireless communications system.

FIG. 5 is a diagram illustrating an example communication flow involving assured frames in a BAN wireless communications system.

FIG. 6 is a diagram illustrating an example communication flow involving assured frames in a BAN wireless communications system.

FIG. 7 is a diagram illustrating an example communication flow involving a poll message in a BAN wireless communications system.

FIG. 8 is a diagram illustrating an example communication flow involve a sleep mode in a BAN wireless communications system.

FIG. 9 is a diagram illustrating an example communication flow in a BAN wireless communications system having multiple followers.

FIG. 10 is a diagram illustrating an example communication flow involving switching roles in a BAN wireless communications system.

FIG. 11 is a diagram illustrating an example communication flow involving switching roles in a BAN wireless communications system.

FIG. 12 is a diagram illustrating an example communication flow involving switching roles in a BAN wireless communications system having multiple followers.

FIG. 13 and FIG. 14 are flowcharts of a method of wireless communication.

FIG. 15 and FIG. 16 are flowcharts of a method of wireless communication.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless communication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A low-power, half-duplex data link layer (DLL) protocol for wireless communication in a BAN is described herein. The protocol that supports devices for different types of applications and devices. The protocol supports both assured and best-effort delivery of data in order to meet the different needs of BAN applications. The protocol supports multiplexing data of different service types from the same application as well as from different applications. The protocol is able to run over different air interface technologies. The protocol is also able to function for both point-to-point links and networks using a start topology.

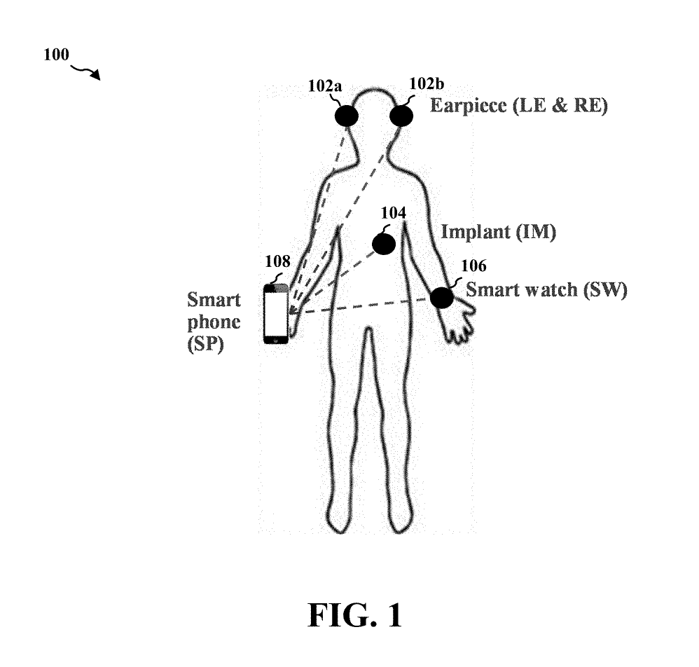

FIG. 1 illustrates an example BAN 100 comprising multiple devices 102a, 102b, 104, 106, 108 receiving and/or transmitting wireless communication according to different applications. The example in FIG. 1 illustrates a BAN comprising, e.g., two ear pieces 102a, 102b in a head set, a medical implant device 104, a smart watch 106, and a wireless device such as a smart phone 108. This is only one example of a BAN, various different devices and applications may be employed in a BAN. Example devices that may be comprised in a BAN include any of wearable or implanted devices for healthcare applications, wearable devices (e.g., a smart watch, an armband, a pedometer, a headset, hearing aids, a heart rate monitor, etc.), as well as other wireless devices such as a mobile telephone, a tablet, a personal digital assistant, laptop, a global positioning system, a multimedia device, a video device, a digital audio player (e.g., MP3 player), a camera, a game console, a tablet, a smart device, or any other similar functioning device that is within range of the BAN and capable of wireless communication with the other devices of the BAN.

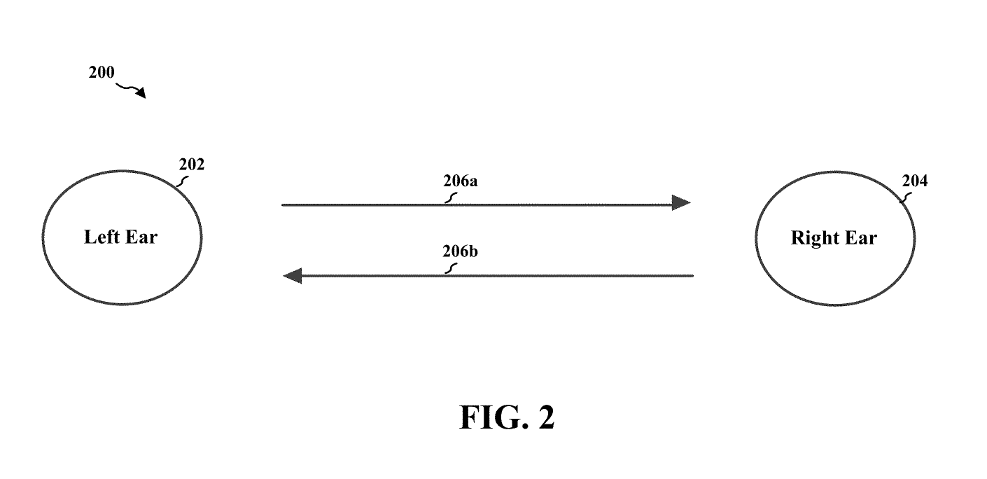

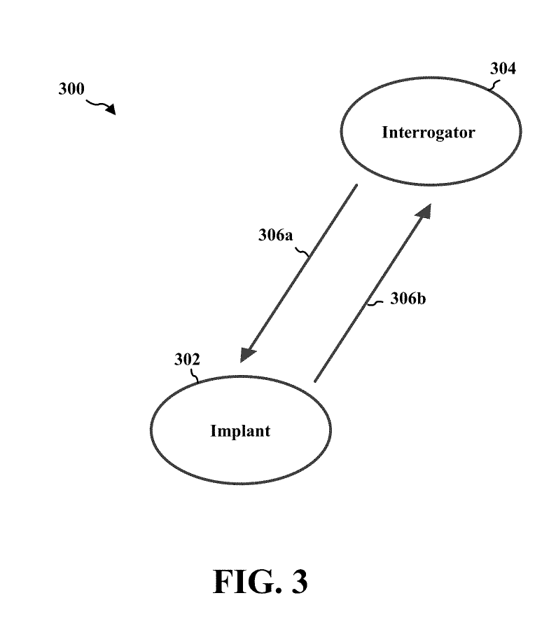

FIG. 1 illustrates a star topology in which the devices 102a, 102b, 104, and 106 communicate with smart phone 108. In other examples, the wireless communication may be point-to-point communication between two individual devices rather than a star topology. FIGS. 2 and 3 illustrate examples of such point-to-point communication.

FIG. 2 illustrates an example BAN system 200 for applications that may include a left ear device 202 and a right ear device 204 transmitting and receiving 206a, 206b wireless communication with each other. The devices 202, 204 may communicate, e.g., using near field communication.

One example application for the system 200 of FIG. 2 is streaming audio to wireless ear pieces that involves ear-to-ear communication. Such wireless communication may include a variable bit rate (VBR) audio stream. The wireless communication may be uni-directional. The communication may have 328˜352 Kbps for higher quality or 229 Kbps for a medium level quality, for example. The communication may need a latency of not more than 20 ms. The communication might not require retransmission, e.g., the payload may be protected by forward error correction (FEC). Configuration and/or control might originate from either side, e.g., from left ear piece 202 or from right ear piece 204. The communication 206a, 206b may involve a low data rate, may be latency tolerant and/or may require reliable delivery.

Another example application for the system 200 of FIG. 2 is a hearing aid application that involves ear-to-ear communication. Thus, ear piece 202 may comprise a left ear hearing aid, and ear piece 204 may comprise a right ear hearing aid. The devices 202, 204 may communicate, e.g., using near field communication. Configuration and control of the wireless communication 206a, 206b may originate from either side device 202, 204. The communication may involve occasional data, e.g., low rate data. The communication may be latency tolerant and may require reliable delivery. The application may involve gain equalization, e.g., which may be bi-directional, on most of the time with a low data rate, latency of not more than 100 ms, and best effort delivery. The application may also involve virtual beamforming of the communication 206a, 206b between the left ear 202 and the right ear 204. Such virtual beamforming communication may be bi-directional, may involve a data rate of not more than 256 Kbps, a latency of not more than 2 ms, best effort delivery, etc.

FIG. 3 illustrates an example BAN system 300 for applications that may include an implant 602 transmitting and receiving 306a, 306b wireless communication with an external device, e.g., interrogator 304. The devices 302, 304 may communicate, e.g., using a Medical Implant Communication Service (MICS) band Radio Frequency (RF). Implant 302 may be a medical device or other device that is implanted into a subject. Configuration and control of the communication may be originate from an exterior device, e.g., the interrogator 304, and be communicated to implant 302. This communication may require a high level of reliability. Data transmissions such as file transfers may occur in both directions, e.g., over 306a and 306b. Such data transmissions between the implant 302 and exterior device 304 may also require a high level of reliability.

A link control protocol provides a way to determine which device, (e.g., 102a, 102b, 104, 106, 108, 202, 204, 302, 304) has access to a link. An asynchronous protocol may be provided rather than time division duplex (TDD). DLL may need to support both asynchronous traffic and synchronous traffic. Frames with different sizes may need to be multiplexed and sent over the same link. An asynchronous protocol may reduce the complexity required to implement the protocol in both hardware and software. For example, as an asynchronous protocol may be event driven, there may be no need for a high precision oscillator for the various devices to stay in synchronization with each other.

The link control protocol presented herein provides for control of a half duplex link in a less complex manner. Aspects may include a leader-follower protocol. A leader device may be established, and a follower device may be required to refrain from transmitting until the follower receives a frame from the leader. Additional features, such as polling, may be used to provide added flexibility. In order to achieve low power operation, the link control protocol may include a sleep mode, in which a leader determines when to sleep and the duration of the sleep period. Applications and devices may determine to use different modes depending on their own needs.

Point-to-Point Example

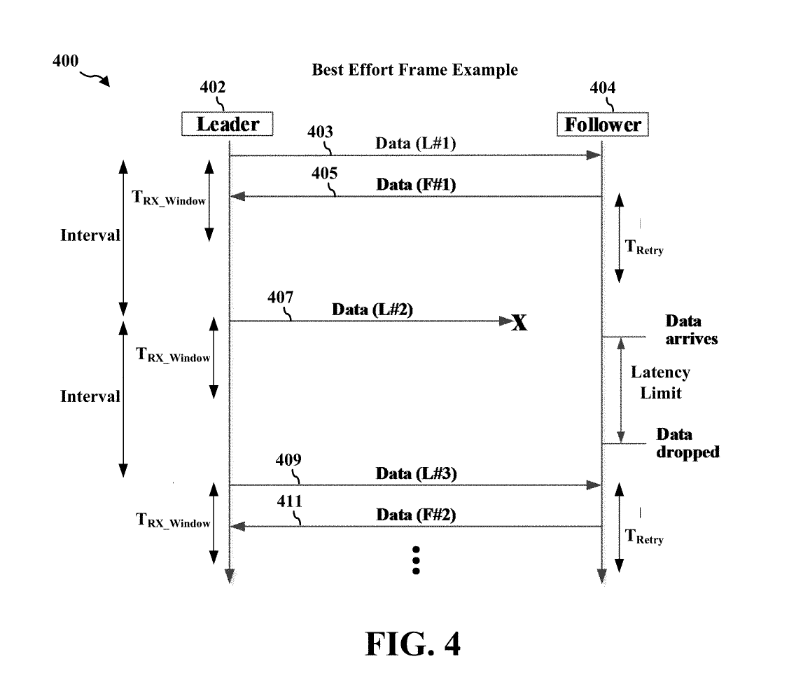

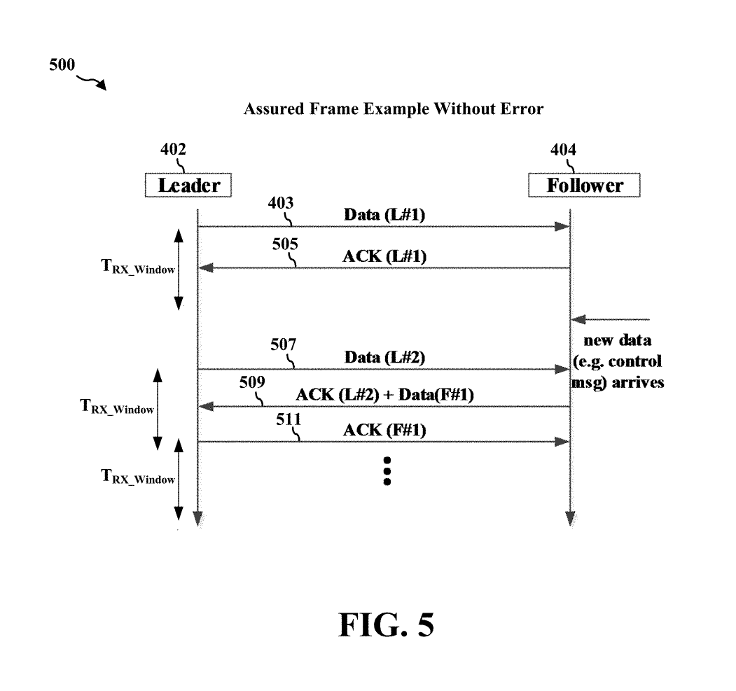

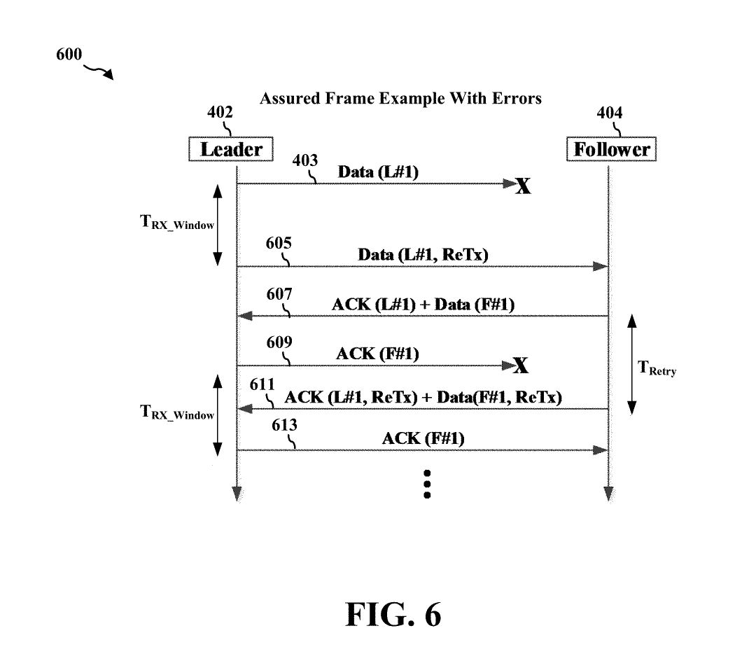

In one example, the link control protocol may be applied to point-to-point communication directly between two devices. Among others, examples of such point-to-point communication may include bi-directional communication between a left ear hearing aid and a right ear hearing aid or communication between a left ear piece and a right ear piece of a headset receiving streaming audio as illustrated in FIG. 2, communication between an implant and external device as illustrated in FIG. 3, communication between a wearable and a smart device, etc. FIG. 4, FIG. 5, and FIG. 6 illustrate examples of point-to-point communication based on aspects of the link control protocol described herein.

During connection setup between two devices that will communicate directly with each other, a leader may be established. For example, the radio device which initiates the connection may take the leader role. In another example, there may be a priority level between devices, and the device with the higher level of priority may be determined to be the leader. The other device will be determined to be the follower. Once the roles of leader and follower are determined, the roles may remain fixed until the roles are re-negotiated. The leader may be able to transmit at any time based on the link control protocol. The transmission from the leader to the follower may trigger a transmission opportunity for the follower to transmit to the leader. Thus, after each transmission to the follower, the leader may refrain from transmitting for a time window (T_{RX}_{_}_{window}) during which the leader waits for the follower to transmit. For example, FIG. 4 illustrates leader device 402 transmitting a first leader transmission 403 to follower device 404. After the first transmission 403, the leader 402 refrains from transmitting for time window T_{RX}_{_}_{window}, which provides the follower 404 with a window to transmit a first follower transmission 405 to leader 402. The interval between transmissions from the leader may be larger than T_{RX}_{_}_{window}, e.g., T_{RX}_{_}_{window} may merely provide for a minimum interval between transmissions from the leader. The interval between transmissions by the leader may also be based on the time window T_{RX}_{_}_{window}, e.g., approximately equal to T_{RX}_{_}_{window}. In one example, if a leader receives a frame from the follower 404 before the time window T_{RX}_{_}_{window} ends, the leader may transmit a next frame of data without waiting for the remainder of the time window T_{RX}_{_}_{window}. According to the link control protocol, the follower may be limited from transmitting until the follower receives a transmission, e.g., a frame, from the leader. Examples of a frame include data, an ACK, etc. Thus, the follower may refrain from transmitting until the follower receives a transmission from the leader. In an example, the follower may be limited to transmitting a single frame at a time. Thus, after the transmission of a single frame at 405, the follower may need to wait until it receives a second frame from the leader before transmitting its own second frame. In other examples, the follower may be allowed to transmit multiple frames within a follower transmission window. For example, a flag indicating more data, e.g., multiple frames, may be included in a frame header from the follower.

FIG. 4 illustrates an example communication flow 400 involving best effort communication between leader 402 and follower 404. Best effort communication might not require an acknowledgement between the devices that the communication was received. In this example, when the follower 404 receives transmission 403 from leader 402, it triggers an opportunity for the follower to transmit data 405 to leader 402. For example, the follower may transmit data 405 as long as the data transmission 405, whether limited to a single frame or involving multiple frames, is able to reach the leader 402 before the window T_{RX}_{_}_{window} expires. If the data transmission 405 would not be able to reach the leader 402 before T_{RX}_{_}_{window} expires, the follower may refrain from transmitting.

In FIG. 4, after transmitting a first data transmission 403, the leader waits for an interval longer than T_{RX}_{_}_{window}, and transmits a second data transmission 407 to follower 404. As illustrated in FIG. 4, the data transmission 407 is not received by the follower. For example, the data may begin to arrive at the follower, but may not be fully received by the follower. As illustrated in FIG. 4, if the data transmission is not received within a latency limit, the data may be dropped by the follower 404. As the follower did not successfully receive the second data transmission 407 from the leader, the follower continues to refrain from transmitting data to the leader 402.

As the communication between leader 402 and follower 404 is best effort communication, the leader may proceed to transmit additional data without waiting for an acknowledgment of successful receipt from the follower. Therefore, after transmitting the second data transmission 407, the leader waits for an interval longer than T_{RX}_{_}_{window}, and transmits a third data transmission 409 to follower 404. The third data transmission 411 may be different than the second data transmission 407 rather than repeating the second data transmission 407.

For a frame that requires more reliable delivery than the best effort communication of FIG. 4, the leader may retransmit the frame when the timer T_{RX}_{_}_{window} expires, e.g., unless the leader receives an ACK letting it know that the frame was received by the follower. FIGS. 5 and 6 illustrate examples involving assured frame communication.

FIG. 5 illustrates an example communication flow 500 involving assured frame communication between leader 402 and follower 404. Aspects that correspond between FIGS. 4, 5, and 6 are labeled with the same reference number. In FIG. 5, the follower is able to transmit to the leader once it receives the first data transmission 403 from the leader. As the communication between the leader and follower in FIG. 5 involves assured frames, the follower responds with an ACK 505 indicating to the leader 402 that the first data transmission 403 was received by the follower. In one example, if a leader receives a frame from the follower 404 before the time window T_{RX}_{_}_{window} ends, the leader may transmit a next frame of data without waiting for the remainder of the time window T_{RX}_{_}_{window}.

As illustrated in FIG. 5, in the interim between transmitting ACK 505, the follower receives new data. Such new data may include a control message, a data message, etc. The follower 404 refrains from transmitting the new data until the follower receives a transmission 507 from the leader 402. Once the follower receives data transmission 507 from the leader 402, the follower 404 is able to transmit the new data. The follower must also acknowledge that data transmission 507 was received. Therefore, the follower transmits a transmission comprising an ACK and the new data at 509. The data may be buffered until the follower is able to send it with an ACK. The ACK and the data may be combined to reduce both transmission time and channel turnaround time. In another example, the data may be transmitted separately from the ACK both transmissions being within window T_{RX}_{_}_{window}. When the leader 402 successfully receives the transmission 509 from the follower, the leader transmits an ACK 511 acknowledging successful receipt of the new data from the follower. In FIG. 5, there are no errors in receiving the communication transmitted between leader 402 and follower 404.

FIG. 6 illustrates an example communication flow 600 involving assured frame communication between leader 402 and follower 404 in which errors occur. In FIG. 6, the follower 404 does not receive the first data transmission 403 from the leader 402. When the leader has not received an ACK from the follower throughout the time window T_{RX}_{_}_{window}, the leader 402 retransmits the first data transmission 605. As the follower 404 did not receive the first data transmission 403, the follower continues to refrain from transmitting until it receives the retransmission 605. The follower is then able to transmit an ACK to the leader 402. The transmission 607 from the follower may also include any data that the follower has been holding for a transmission opportunity. For example, the follower may buffer data until the data can be sent with an ACK. The leader receives the transmission 607 that includes both the ACK and data from the follower. The leader 402 then transmits an ACK 609 that the data in transmission 607 was received. However, ACK 609 is not received by the follower 404. When the follower 404 does not receive an ACK to a data transmission, e.g., 607, within a time window T_{retry} following the data transmission, the follower 404 may retransmit the data transmission. T_{retry} may be configured to be shorter than the leader time out window T_{RX}_{_}_{window}. This enables the follower to retransmit within T_{RX}_{_}_{window} and to avoid collisions with transmissions from the leader. Therefore, the follower retransmits the ACK and data from transmission 609 as a retransmission 611. When the leader receives the retransmission, the leader transmits an ACK 613 to the follower. The leader or follower may continue to retransmit a data transmission multiple times, in the manner illustrated in FIG. 6, until an ACK is received for the data transmission. For example, the retransmissions from the follower 404 may be limited to a number of retransmissions that the follower can transmit within the time window T_{RX}_{_}_{window}.

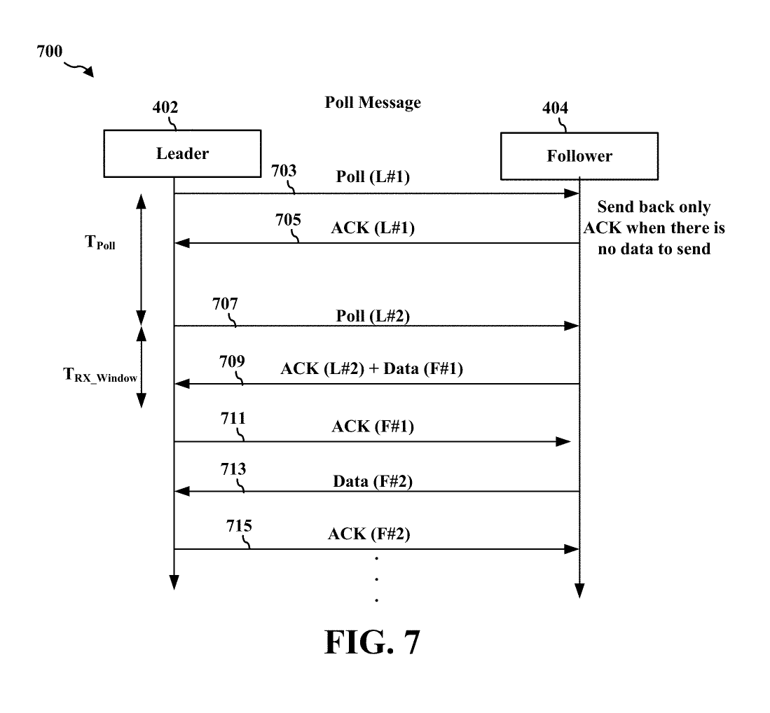

FIG. 7 illustrates an example communication flow 700 involving a poll message between leader 402 and follower 404. A poll message may involve a transmission from leader 402 to follower 404 that provides the follower 404 with a transmission opportunity when the leader itself does not have data for transmission. Therefore, if leader 402 has data to transmit, the leader may transmit the data as described in connection with FIG. 4, 5, or 6. The leader may be configured to provide a transmission opportunity to the follower after an amount of time, T_{Poll} during which the leader does not transmit a data transmission. For example, an implant 302 may need to upload data, e.g., a file, to interrogator 304 acting as leader 402 while implant acts as the follower 404. In FIG. 7, leader 402 transmits a poll message 703. If the follower 404 does not have data to be transmitted when it receives the poll message 703, the follower responds by transmitting an ACK 705 indicating that it received the poll transmission 703. If no ACK is received, e.g., within T_{RX}_{_}_{window}, the leader may assume that the follower did not receive the poll message 703 and may retransmit the poll message. When the leader 402 does not need to transmit for another period T_{Poll}, the leader 402 may send another poll transmission 707. In FIG. 7, when the follower 404 receives the second poll message 707, the follower has data buffered for transmission. Therefore, the follower 404 uses its opportunity to transmit in response to receiving transmission 707 to transmit a transmission 709 that includes both an ACK that the second poll transmission 707 was received and the buffered data. In another example, the ACK and the data may be transmitted in separate transmissions in response to receiving poll transmission 707. As the transmission 709 includes data, the leader responds by transmitting an ACK 711 that the data in transmission 709 was received. The ACK 711 may trigger another opportunity for follower 404 to transmit. Therefore, the follower 404 may transmit a second data transmission 713 in response to receiving the ACK 711 from the leader 402. When the leader 402 receives the second data transmission 713 from the follower, the leader may transmit an ACK 715 to the follower 404 that the second data transmission 713 was successfully received. Similar to the ACK 711, ACK 715 is a transmission received from the leader 402 and triggers a transmission opportunity for follower 404. Thus, ACKs from the leader 402 may continuously trigger, or provide opportunities for, data transmissions from the follower 404. A maximum number of retransmissions for a poll message may be configurable. For example, after the leader has transmitted poll messages the configured number of times without receiving data from the follower, the leader may discontinue the poll messages, e.g., for a configured amount of time. In another example, the time between poll messages may be extended after the configured number of retransmissions.

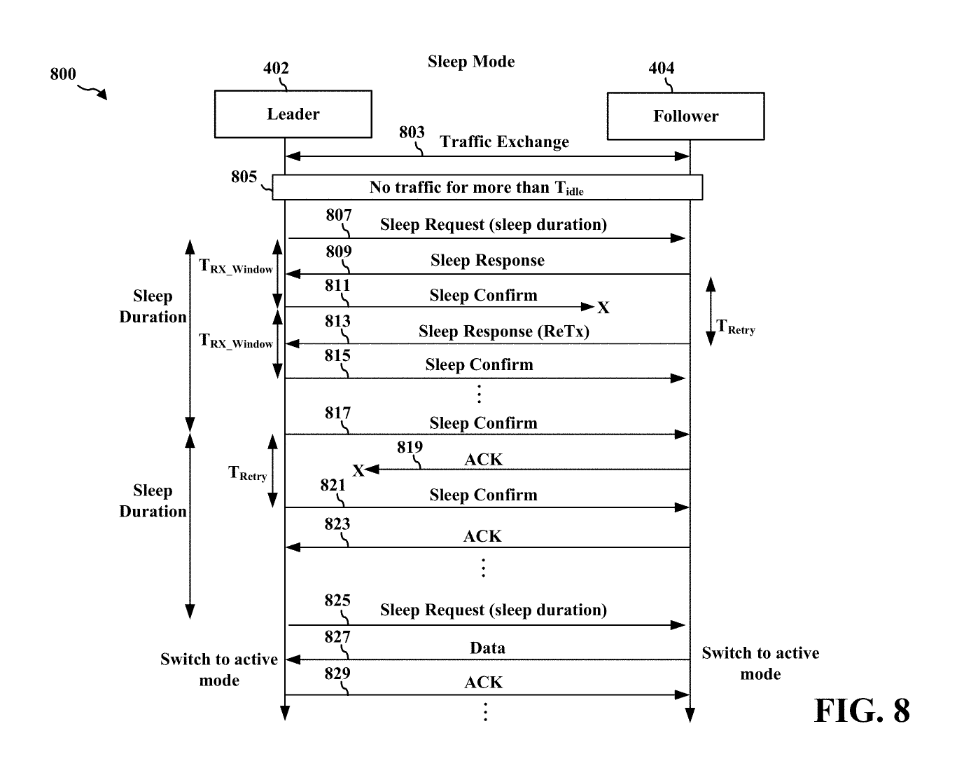

FIG. 8 illustrates an example communication flow 800 between leader 402 and follower 404 involving a sleep mode. For example, after traffic exchange 803 between leader 402 and follower 404, which may include aspects described in any of FIGS. 4, 5, 6, and 7, both leader and follower might not have traffic to transmit. When there has been no traffic for transmission for at least a period T_{idle}, a sleep mode may be entered. For example, the leader may determine that there has not been traffic when only poll messages and ACKs to the poll messages have been exchanged for at least a period T_{idle}, as illustrated at 805. In another example, a configured number of poll message retransmission may have been transmitted. Once such a threshold has been reached, whether based on time or poll retransmissions, the leader may determine to initiate a sleep mode. The sleep mode initiation may include a three way handshake between the leader 402 and follower 404. The three way handshake may include establishing a mutually agreed upon sleep duration. In order to begin initiating a sleep mode, the leader 402 may transmit a sleep request 807. The sleep request 807 may include a sleep duration. If the follower 404 agrees to enter the sleep mode and agrees to the sleep duration, the follower transmits a sleep response 809. When the leader 402 receives the sleep response 809 from the follower, the leader 402 may transmit a sleep confirm indication 811. In FIG. 8, the follower does not receive sleep confirm 811. After a period T_{retry}, the follower retransmits the sleep response 813. The leader 402 response with sleep confirm 815. Once the follower receives the sleep confirm transmission 815, the follower enters the sleep mode, e.g., for the sleep duration indicated in the sleep request 807. For example, the sleep duration may begin from the time that a sleep confirmation message is sent. If a sleep confirmation message is retransmitted, the timer for the sleep duration may be reset.

When the sleep duration ends, if the leader does not have data for transmission, the leader transmits a sleep confirm indication 817 to indicate to continue the sleep mode for another sleep duration. When the follower receives the sleep confirm 817, the follower 404 responds with an ACK 819. The ACK 819 is not received by the leader 402. When the leader does not receive an ACK to the sleep confirm 817, e.g., for a period T_{retry}, the leader retransmits the sleep confirm 821. The follower transmits an ACK 823 in response to the sleep confirm 821 and enters sleep mode. When the leader receives the ACK 823, the leader also enters the sleep mode. At the end of the second sleep duration, the leader may send another sleep confirm and so forth until the leader has data to transmit.

FIG. 8 illustrates that the leader 402 may transmit another sleep request 825 to follower 404. The sleep request 825 may include a sleep duration, which may be the same or different than the sleep duration in sleep request 807. At this point of FIG. 8, the follower has data to transmit. The follower may have been buffering the data until it received a transmission from the leader, which triggers a transmission opportunity for the follower. At 827, the follower responds to the sleep request 825 with a data transmission. Thus, the follower has switched from sleep mode to active mode in order to transmit the data. When the leader 402 receives data 827, the leader also switches to active mode and transmits ACK 829 to follower acknowledging the receipt of data 827. Although FIG. 8 illustrates the follower 404 transmitting data in response to a sleep request, the follower may transmit data in response to a sleep confirm transmission from the leader 402 (e.g., sleep confirm 815, 817, or 823). The follower will send an ACK 823 only when the follower does not have data to transmit to the leader 402. When the leader receives a data frame instead of an ACK, the leader switches back to an active mode.

As the link control protocol is asynchronous, the protocol may need to handle clock drift between devices, e.g., between leader 402 and follower 404. A leader may retransmit a sleep confirm message multiple times, e.g., around an expected wake up time. This may help to address potential clock drift between the leader 402 and follower 404. The number of times that the sleep confirm message is retransmitted may be configurable in order to accommodate different clock accuracies.

Additional options may be implemented in a sleep mode. In a first example, when in a sleep mode, a follower may receive a sleep confirm message (e.g., 815, 817, or 821) and may use a preamble of the sleep confirm message to calibrate its local clock. In a second example, when in the sleep mode, the follower may wake up earlier than the scheduled time based on the sleep duration, in order to accommodate for an anticipated clock drift.

Star Topology

The aspects of the link control protocol may also be applied in a BAN having a star topology in addition to use in point-to-point communication. In communication involving a star topology, a single leader device may communicate with multiple follower devices in the BAN. The example BAN of FIG. 1 illustrates a smart phone 108 as a leader and communicating with followers including ear pieces 102a, 102b, implant 104, and smart watch 106.

Each class of device in the BAN may have a provisioned priority for becoming a leader for the BAN. For example, a smart phone may have a higher priority than a smart watch, which may have a higher priority than an earpiece. An implant may have a lower priority than an earpiece. Some devices or classes might be restricted from ever being the leader. For example, an implant may be restricted from becoming the leader for the BAN. The equation below illustrates an example priority scheme:
smart phone >>smart watch >>earpiece >>implant

For devices within the same class, a leader may be determined in a different manner. For example, devices within a same class may use random access to determine which device can become the next leader.

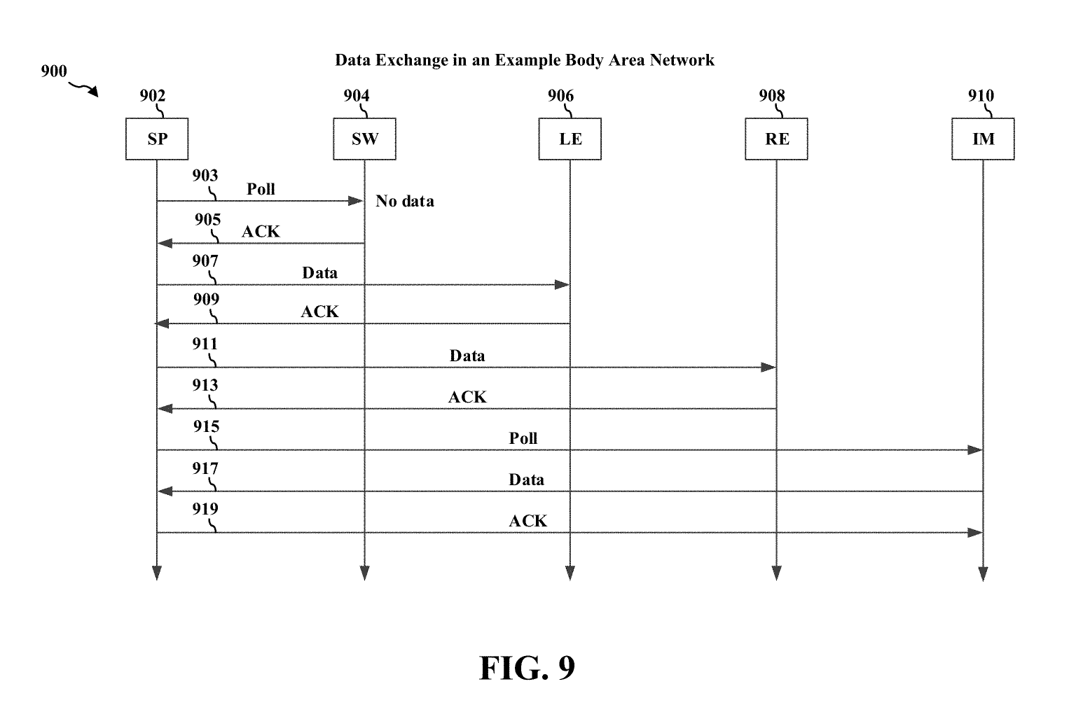

For simplicity of presentation, in the example illustrated in FIG. 9, a leader is illustrated as being able to reach, e.g., transmit directly to, every device in the BAN. Some devices in the BAN may not be able to receive transmissions from at least one other device in the BAN. Master devices, e.g., devices that are likely to be established as the leader or that are capable of functioning as a leader, may be able to transmit to/receive transmissions from all of the other devices in the BAN, e.g., due to their larger size and power capabilities.

FIG. 9 illustrates an example communication flow 900 involving data exchange in an established star topology BAN. In FIG. 9, smart phone 902 has been established as the leader and has full control of data exchange in the BAN comprising the smart phone 902, smart watch 904, left ear piece 906, right ear piece 908, and implant 910. The diagram in FIG. 9 is merely one example, any number of different devices may be included in the BAN, and the aspects described in connection with FIG. 9 may be applied to those additional devices. As a part of being established as the leader, the leader may establish a connection with each device in the BAN as followers of the leader. The leader may then communicate with each of the followers using point-to-point communication using the leader-follower protocol, as described in connection with any of FIGS. 4, 5, 6, 7, and 8.

The leader may communicate with the followers 904, 906, 908, 910 in any order that it chooses. The order may be based on a round robin pattern or a different pattern or priority. Each of followers 904, 906, 908, 910 may refrain from transmitting until the corresponding follower receives a transmission from the leader 902, whether the transmission be a data transmission, an ACK, a poll message, a sleep request, a sleep confirm, etc. Receiving the transmission from the leader provides a transmission opportunity for the follower to transmit a transmission, e.g., within a period of time T_{RX}_{_}_{window}.

FIG. 9 illustrates smart phone 902 transmitting a poll message 903, as leader, to smart watch 904, as a follower. The smart watch does not have any data for transmission and responds with ACK 905. If the smart watch 904 did have data, the smart watch may have responded by transmitting the data to the smart phone. The smart phone 902 then transmits a data transmission 907, as the leader, to left ear piece 906, as a follower. The left ear piece 906 responds with an ACK 909. If the left ear piece had data for transmission to the smart phone 902, the transmission at 909 may have also included the data transmission. At 911, the smart phone transmits a data transmission to the right ear piece 908, as a follower. The right ear piece 908 responds with an ACK 913. If the right ear piece 908 had data for transmission to the smart phone 902, the transmission at 913 may have also included the data transmission. At 915, the smart phone 902 transmits a poll message 915 to implant 910. For example, the smart phone 902 might not have data for transmission to the implant and may transmit the poll message, as the leader, to provide the implant with an opportunity to transmit to the smart phone. The implant 910 responds by transmitting data 917. The smart phone 902 then responds with an ACK 919 indicating to the implant 910 that the data 917 was received.

The leader may communicate with the followers 904, 906, 908, 910 in any order that it chooses. For example, the leader may maintain a round-robin type pattern of communicating with each of the followers to ensure that each follower has an opportunity to transmit to the leader. In another example, the order of communication or the pattern of communication may be different depending on the type of follower device. For example, certain followers may need more frequent opportunities to transmit than others. If the leader does not have data to transmit to individual followers, the leader may transmit a poll message.

Role Switch Between Leader and Follower

At times, the leader role in a BAN may need to change to a different device. For example, the leader in a BAN may change as devices leave or rejoin the BAN. For example, a leader may leave the BAN, and a new leader may need to be identified. In another example, a higher priority device may join the BAN, and the current leader may be replaced. In other examples, a leader may indicate that it will relinquish its role as leader. A role switch protocol may be used to select a new leader.

A leader may announce to release its role by sending a Leader Release message. After receiving a Leader Release message, a follower may choose to either take over the leader role or refrain from taking over the leader role. If more than one device indicates an intention to assume the leader role, the devices may contend for the leader role. For example, leader may be determined based on a priority level associated with the devices. In another example, the devices may contend for the role through a random access procedure.

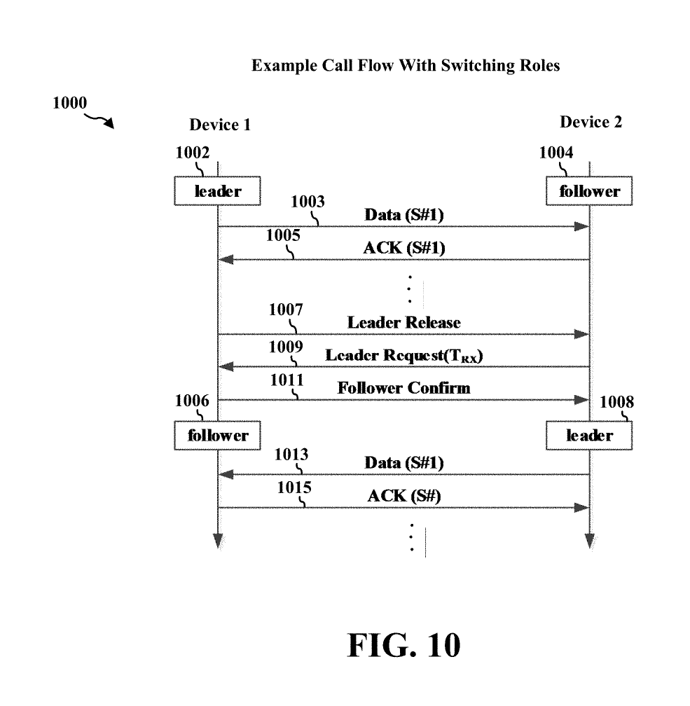

FIG. 10 illustrates an example communication flow 1000 involving a switching of roles between two devices in a BAN, e.g., Device 1 and Device 2. Initially, Device 1 is the leader 1002, and Device 2 is the follower 1004. The leader 1002 and follower 1004 exchange communication, e.g., such as data 1003 and ACK 1005. The follower 1004 is limited to transmitting only when the follower 1004 receives a transmission from the leader. The leader 1002 and follower 1004 may communicate using any of the aspects described in connection with FIGS. 4-9. At some point, the leader 1002 may indicate that it will no longer perform the leader role. The leader 1002 transmits a leader release 1007 indication to follower 1004. Although only a single follower is illustrated, similar communication may be sent by leader to multiple followers. At 1009, the follower transmits a leader request indicating an intention to perform the leader role in communication between the two devices. The leader request message 1009 may include an indication of the amount of time for T_{RX}_{_}_{window}, when the follower 1004 acts as the leader. This will enable both sides of the communicate to be aware of the window that will be used if the follower 1004 becomes the leader. The leader 1002 responds with a follower confirm transmission 1011 indicating that it will switch roles with follower 1004 and will become a follower. Thus, Device 1, which was initially leader 1002, becomes follower 1006. Device 2, which was initially follower 1004 becomes the leader 1008. At this point, the leader 1008 may transmit at any point, but follower 1006 cannot transmit until follower 1006 receives a transmission from leader 1008. For example, new leader 1008 may transmit data 1013. This triggers an opportunity to transmit at follower 1006. In FIG. 10, follower 1006 does not have data to transmit and merely transmits an ACK 1015.

The leader 1002 may reject the leader request 1009. Such a rejection may effectively reject the BAN.

In another example, the leader 1002 may appoint a new leader. The leader release 1007 may include an indication of the new leader selected by the leader 1002 In other examples, the leader 1002 may select the new leader based on the follower confirm message 1011.

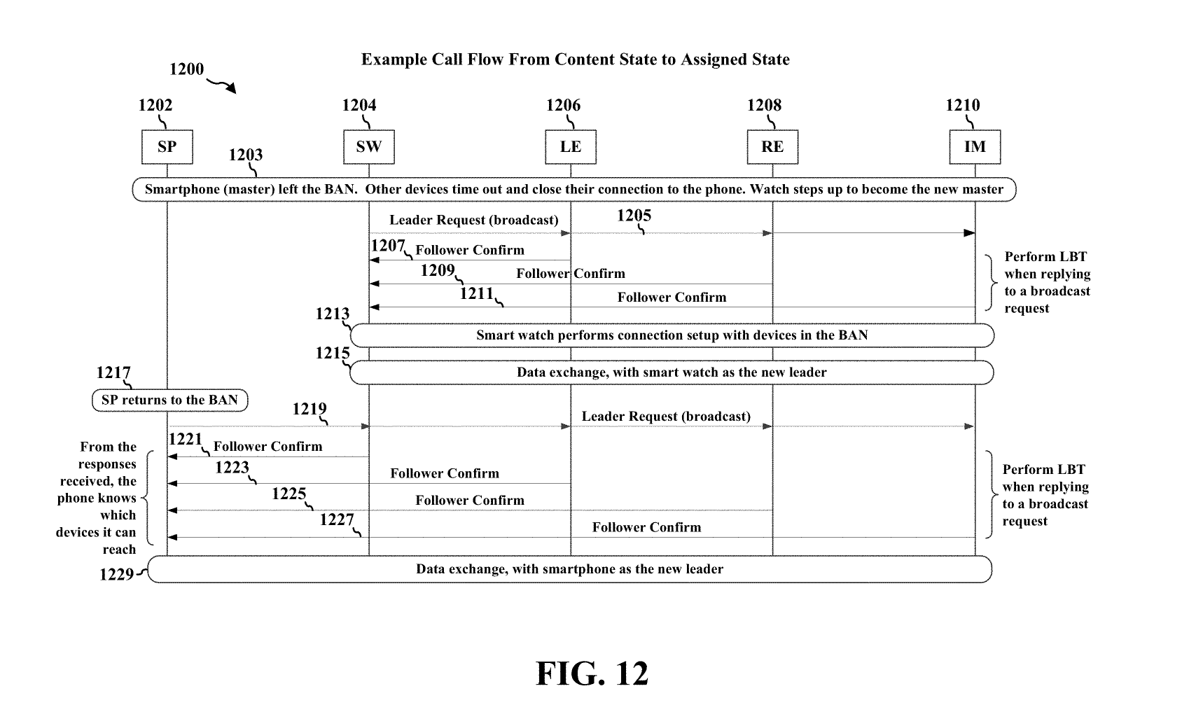

For example, FIG. 12 illustrates an example of a leader with multiple followers. In this example, the current leader may select the next leader by confirming only a single new leader request. The new leader may be selected based on a priority associated with each of the followers in the BAN. For example, a priority list may indicate the next highest priority device that should be selected as the new leader.

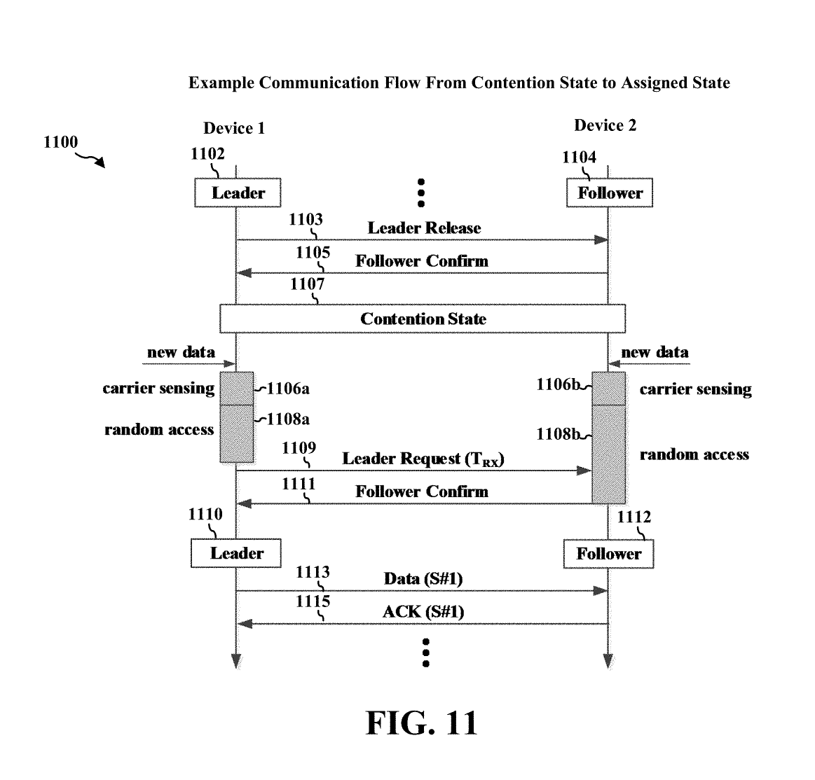

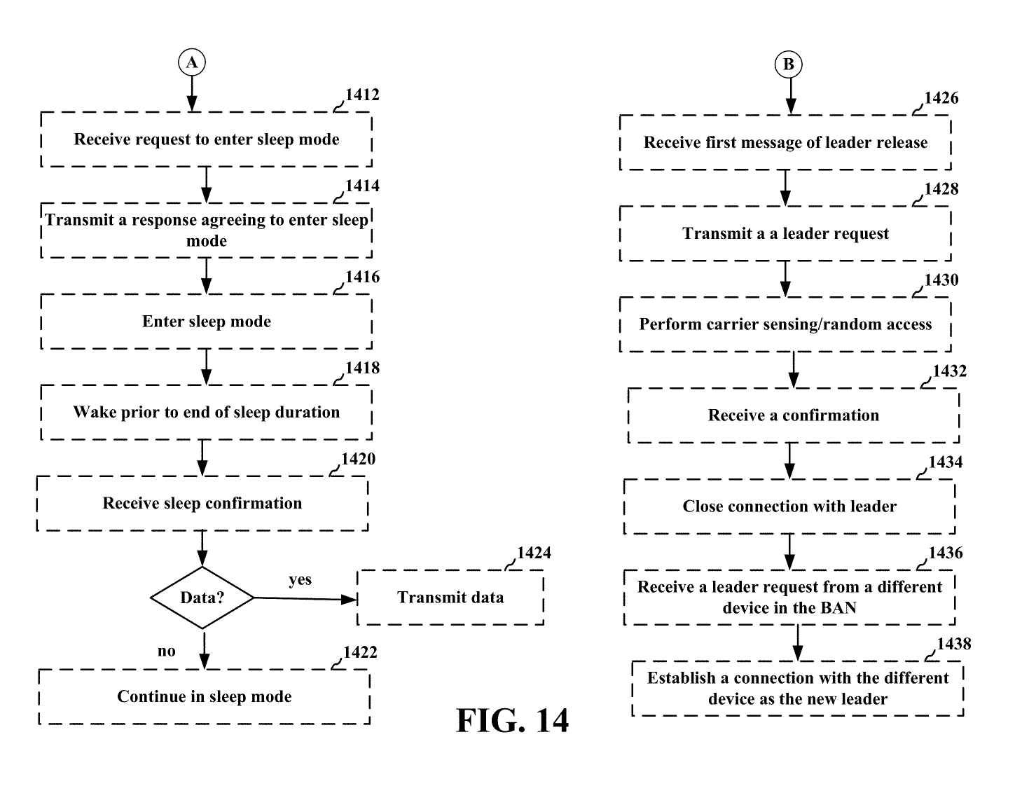

FIG. 11 illustrates an example communication flow 1100 involving contention for a new leader between two devices Device 1 and Device 2 in a BAN. In FIG. 1111, initially the two devices have established a leader and a follower 1104, which may communicate as described in connection with FIGS. 4-9. The leader 1102 transmits a leader release 1103 to follower 1104 indicating that the Device 1 will no longer perform the actions of the leader. The follower 1104 may transmit follower confirm 1105 indicating that the follower received the leader release 1103. No leader is established, and Device 1 and Device 2 enter a contention state 1107 in which a contention procedure may need to be performed in order to establish a new leader. While in the contention state, both Device 1 and Device 2 receive or generate new data to transmit to the other device. Both devices may perform a contention procedure, e.g., including performing carrier sensing at 1106a, 1106b and performing random access at 1108a, 1108b. For example, during the carrier sensing 1106a, 1106b the two devices may monitor the carrier to sense whether communication is being transmitted by another device. If the devices do not detect such communication on the carrier, the device may wait a random period and transmit a leader request. Whichever device first transmits the leader request may become the new leader. In FIG. 14, Device 1 transmits leader request 1109. Device 2 then responds with a follower confirm transmission 1111. At that point, Device 1 has been reestablished as the leader 1419 and Device 2 is the follower 1112. In these roles, the leader may transmit the new data, but the follower 1112 must wait until a transmission is received from the leader 1110 in order to transmit the new data. Leader 1110 transmits the new data 1113 to the follower 1112, and the follower transmits ACK 1115 acknowledging the receipt of the data from leader 1110. The follower may also transmit data along with ACK 1115.

FIGS. 10 and 11 illustrate examples involving establishing a new leader between two devices. These aspects may also be applied to a BAN involving a leader and multiple followers. FIG. 12 illustrates an example communication flow 1200 involving a leader change in a BAN involving multiple followers. In FIG. 12, smart phone 1202 is initially established as the leader and has full control of data exchange in the BAN comprising the smart phone 1202, smart watch 1204, left ear piece 1206, right ear piece 1208, and implant 1210. The diagram in FIG. 12 is merely one example, any number of different devices may be included in the BAN, and the aspects described in connection with FIG. 12 may be applied to those additional devices. As the leader, the smart phone had a connection with each device in the BAN and communicated with each of the followers (1204, 1206, 1208, 1210) using point-to-point communication using the leader-follower protocol, as described in connection with any of FIGS. 4-9. At 1203, the smartphone 1202 leaves the BAN. The connection with the smartphone may time out at the follower devices in the BAN (1204, 1206, 1208, 1210), and the follower devices may close their connection to the smartphone 1202. The smart watch 1204 transmits a leader request transmission 1205. The leader request 1205 may be broadcast to each of the other devices in the BAN (e.g., 1206, 1208, 1210). The devices receiving the leader request 1205 may perform a listen before talk (LBT) procedure before replying to the broadcast request 1205. After performing LBT, the devices 1206, 1208, and 1210 may each transmit a follower confirm transmission to the smart watch 1204 (e.g., 1207, 1209, 1211). The smart watch then performs connection set up at 1213 with each of the devices in the BAN in order to establish a connection with each device in the BAN. At 1215, the smart watch exchanges data, as the new leader, with each of the devices of the BAN. The smart watch may function as the leader and exchange communication, e.g., as described in connection with FIG. 9. This communication exchange may continue until an indication that a new leader should be established. For example, the smart watch may leave the BAN, as the smart phone did. As another example, the smart watch may transmit a message indicating that it will no longer operate as the leader in the BAN. As another example, another device may join the BAN causing selection of a new leader. For example, a device with a higher priority to be the BAN leader may join the BAN. In FIG. 12, the smartphone 1202 returns to the BAN at 1217. The smartphone may broadcast or otherwise transmit a leader request 1219. The smartphone may indicate its priority to be established as the BAN leader along with the leader request 1219. The potential followers may use the indicated priority to determine whether to transmit a follower confirm transmission in response to the leader request 1219. The other devices 1204, 1206, 1608, 1210, may perform a LBT before replying to the leader request 1219. After performing LBT, the devices 1204, 1206, 1208, and 1210 may each transmit a follower confirm transmission to the smart watch 1204 (e.g., 1221, 1223, 1225, 1227). The smart phone 1202 then establishes a connection with each device in the BAN. At 1229, the smart watch exchanges data, as the new leader, with each of the devices of the BAN.

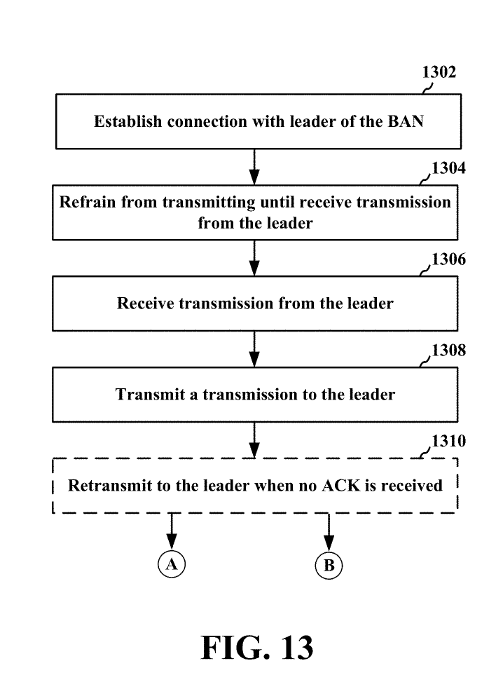

FIGS. 13 and 14 are flowcharts of a method of wireless communication. The method may be performed by a follower in a BAN (e.g., any of the wireless devices 102a, 102b, 104, 106, 108, 202, 204, 302, 304, 404, 904, 906, 908, 910, 1004, 1006, 1104, 1110, 1204, 1206, 1208, 1210, the apparatus 1702. At 1302, the follower establishes a connection with a leader in the BAN (e.g., 402, 902, 1002, 1008, 1102, 1112, 1202, etc.). At 1304, the follower refrains from transmitting until a transmission is received from the leader, as described in connection with FIGS. 4-12, wherein the transmission received from the leader triggers a transmission opportunity at the follower for a window of time, e.g., T_{RX}_{_}_{window}. For example, the follower may be limited to transmitting according to a leader-follower protocol.

At 1306, the follower receives the transmission from the leader. The transmission from the leader comprises at least one of a data transmission, a poll transmission, an ACK, and a sleep mode message, e.g., as described in connection with FIGS. 4-9. At 1308, the follower transmits a second transmission to the leader within the window of time. The second transmission transmitted at 1308 may comprise an ACK to the transmission from the leader when there is no data for transmission from the follower, e.g., as illustrated for 505, 705, 823, 905, 909, 913, 1005, etc. The second transmission transmitted at 1308 may comprise the ACK to the transmission from the leader multiplexed with a data transmission when the data transmission is waiting for transmission from the follower, e.g., as illustrated for 509, 709, etc. The follower may be limited to transmitting a single frame during the transmission opportunity. In other examples, the follower may be able to transmit multiple frames during the transmit opportunity, but may be limited to transmitting a number of multiple frames during the transmission opportunity that can be received by the leader during the window of time.

At 1310, the follower may retransmit the second transmission to the leader when an ACK is not received within a second window of time, e.g., T_{Retry}. The second window of time may be shorter than the first window of time, e.g., in order to avoid collisions.

Aspects may include a sleep mode, as described in connection with FIG. 8. FIG. 14 illustrates additional aspects of the method of claim 13. For example, at 1412, the follower may receive a request to enter a sleep mode from the leader. At 1414, the follower may transmit a response to the leader agreeing to enter the sleep mode. At 1416, the follower may enter the sleep mode, e.g., when a confirmation message is received from the leader. The request to enter the sleep mode may comprise an indication of a sleep duration, wherein the follower enters the sleep mode for the sleep duration.

At 1420, the follower may receive a sleep confirmation message from the leader following the sleep duration. In response to the sleep confirmation message, the follower may continue in the sleep mode when there is no data for transmission from the follower at 1422 or may transmit a data transmission in response to the sleep confirmation message at 1424 when the data transmission is waiting for transmission from the follower. The sleep confirmation message received at 1420 may comprise a preamble that the follower uses to calibrate a clock at the follower.

In order to adjust for potential clock drift, the follower may wake up prior to the end of the sleep duration at 1418.

Aspects may also include switching roles between follower and leader of the BAN, as described in connection with any of FIGS. 10-12. At 1426, the follower may receive a first message indicating that the leader releases leadership of the BAN. If the follower determines that it should assume the leader role of the BAN, the follower may transmit a second message requesting to be established as a new leader of the BAN at 1428. At 1432, the follower receives a confirmation message confirming the follower as the new leader of the BAN. The follower may then establish a connection as the new leader of the BAN. The follower may perform carrier sensing and random access at 1430 prior to transmitting the second message, e.g., as described in connection with FIG. 11.

In another example, the follower may be part of a BAN with multiple followers, e.g., as described in connection with FIG. 12. Thus, a different follower device may switch to the role of leader. In this example, the follower may receive the first message at 1426 indicating that the leader releases leadership of the BAN. In response, the follower may close a connection to the leader at 1434. At 1436, the follower may receive a second message from a different device requesting to be established as a new leader of the BAN. At 1438, the follower may establish a connection with the different device as the new leader of the BAN.

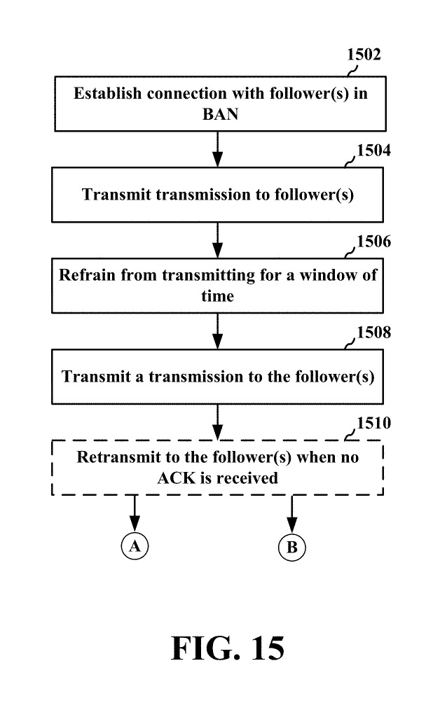

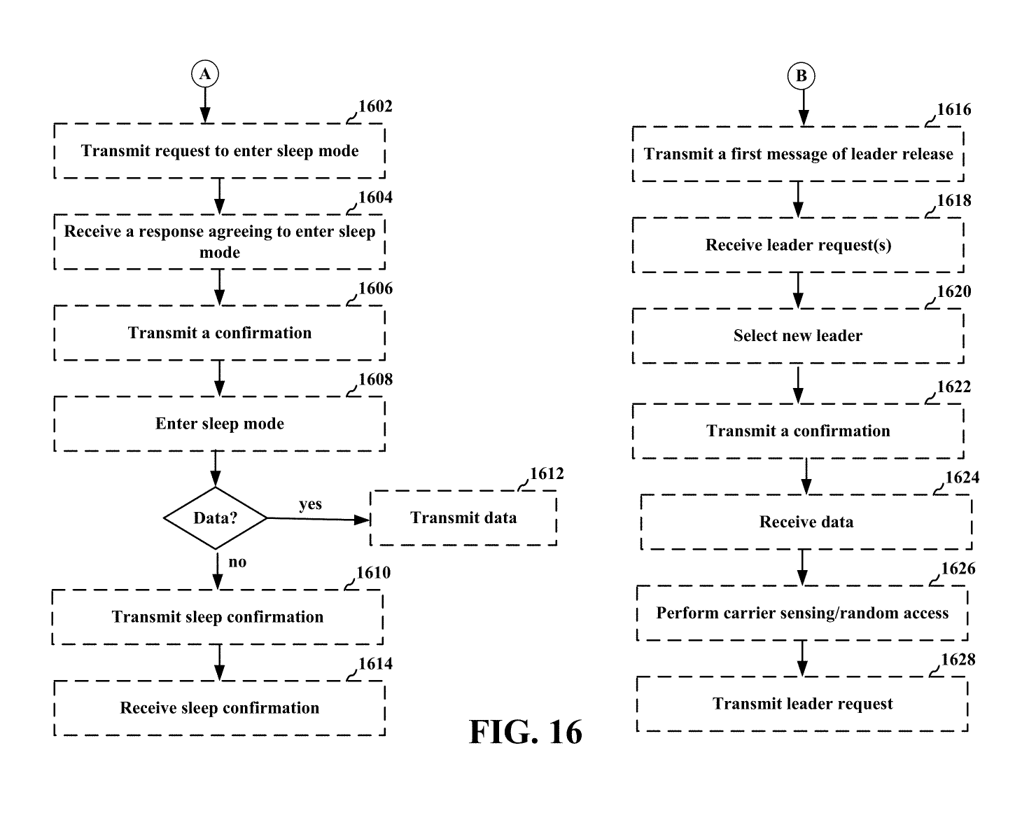

FIGS. 15 and 16 are flowcharts of a method of wireless communication. The method may be performed by a leader in a BAN (e.g., any of the wireless devices 102a, 102b, 104, 106, 108, 202, 204, 302, 304, 402, 902, 1002, 1008, 1102, 1112, 1202, the apparatus 1702. At 1502, the leader establishes a connection with at least one follower in the BAN (e.g., 404, 904, 906, 908, 910, 1004, 1006, 1104, 1110, 1204, 1206, 1208, 1210, etc.). For example, the leader may establish a connection with multiple followers in the BAN, wherein the leader communicates with each of the multiple followers based on the leader-follower protocol, e.g., as described in connection with FIG. 9. The leader may communicate with each of the multiple followers based on point-to-point communication between the leader and the corresponding follower, e.g., using any of the aspects described in connection with FIGS. 4-8.

At 1504, the leader transmits a transmission to the at least one follower. The transmission may comprises any of a data transmission, a poll transmission, an ACK, or a sleep mode message, as described in connection with FIGS. 4-9. For example, the transmission may comprise a poll transmission that is transmitted when the leader does not have data for transmission to the at least one follower for a threshold period of time, e.g., as described in connection with FIG. 7.

At 1506, the leader refrains from transmitting for a window of time, e.g., T_{RX}_{_}_{window}, following the transmission according to a leader-follower protocol, wherein the window of time corresponds to a transmission opportunity for the at least one follower. The leader may continue to transmit to the follower, e.g., at 1508, spaced at least by a window of time to allow for transmissions by the follower. For example, the leader may retransmit to the follower at 1510 when no ACK is received from the follower.

The wireless communication may include a sleep mode, e.g., as described in connection with FIG. 8. FIG. 16 illustrates a continuation of the method of FIG. 15. For example, at 1602, the leader may transmit a request to enter a sleep mode to the follower. At 1604, the leader may receive a response to the leader agreeing to enter the sleep mode. At 1606, the leader may transmit a confirmation message and may enter the sleep mode at 1608.

The request to enter the sleep mode may comprise an indication of a sleep duration, wherein the leader enters the sleep mode for the sleep duration.

The leader may transmit a sleep confirmation message to the follower at 1610 following the sleep duration when there is no data for transmission to the follower. The leader may transmit a data transmission at the end of the sleep duration at 1612, when the data transmission is waiting for transmission to the follower.

The sleep confirmation message may comprise a preamble for clock calibration at the follower.

The leader may transmit multiple repetitions of a sleep confirmation message at 1614 surrounding an end of the sleep duration.

The wireless communication may include switching roles, e.g., as described in connection with FIGS. 10-12. For example, at 1616, the leader may transmit a first message indicating that the leader releases leadership of the BAN. At 1618, the leader may receive a second message from the follower requesting to be established as a new leader of the BAN. At 1622, the leader may transmit a confirmation message confirming the follower as the new leader of the BAN.

In another example, the leader may release leadership and later rejoin the BAN. Thus, at 1616, the leader may transmit a first message indicating that the leader releases leadership of the BAN. Then, the leader may receive data for transmission to a follower in the BAN at 1624. The leader may perform carrier sensing and random access at 1626 and may transmit a second a second message requesting to be established as a new leader of the BAN at 1628, e.g., as described in connection with FIG. 11.

Additionally, the leader may have multiple followers. The leader may need to select or otherwise identify the new leader among the followers of the BAN, as described in connection with FIG. 12. Therefore, after transmitting the first message indicating a release of leadership of the BAN at 1616, the leader may receive multiple messages from multiple followers at 1618 requesting to be established as a new leader of the BAN. The leader may then select one of the multiple followers as the new leader of the BAN at 1620, as described in connection with FIG. 12. Then, at 1622, the leader may transmit a second message confirming the new leader of the BAN based on the selection at 1620.

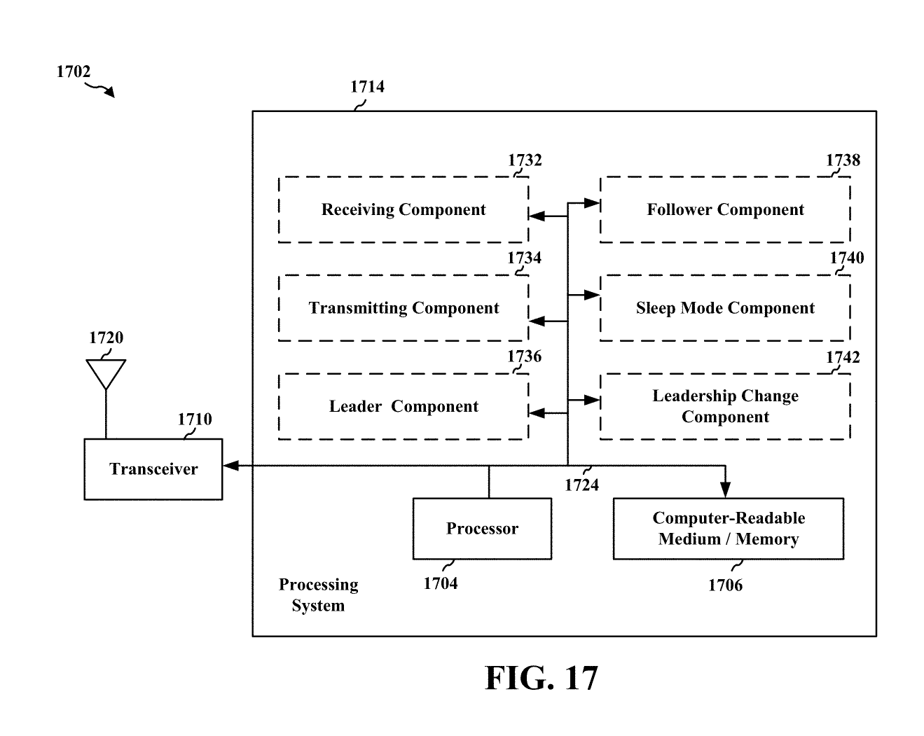

FIG. 17 is a diagram illustrating an example of a hardware implementation for an apparatus 1702, also referred to herein as a wireless communication device, employing a processing system 1714. The apparatus may be comprised in or may comprise any of devices 102a, 102b, 104, 106, 108, 202, 204, 302, 304, 902, 904, 906, 908, 910, 1202, 1204, 1206, 1208, 1210. Different devices in a BAN may operate as leader or a follower at different times. Thus, the apparatus may similarly operate as a follower and/or leader, as described in connection with any of FIGS. 4-15. The apparatus 1702 may comprise a reception component 1732 configured to receive wireless communication from devices in a BAN and a transmission component 1734 configured to transmit wireless communication to other devices in the BAN

The apparatus 1702 may include a leader component 1736 configured to operate the apparatus as a leader of a BAN, e.g., as described in connection with any of the aspects of FIGS. 4-9, 15, and 16. The apparatus 1702 may include a follower component 1738 configured to operate the apparatus as a follower in a BAN, e.g., as described in connection with any of the aspects of FIGS. 4-9, 12, and 13. The follower component 1738 may be configured to refrain from transmitting until a transmission is received from the leader of the BAN, for example. The apparatus 1702 may include a sleep mode component 1740 configured to operate the apparatus in connection with a sleep mode, e.g., by performing any of the aspects described in connection with FIGS. 8, 14, and 16. The apparatus 1702 may include a leadership change component 1742 configured to operate the apparatus in connection with a change in the leader of a BAN, e.g., as described in connection with any of the aspects of FIGS. 10-12, 14, and 16.

The apparatus may include additional components that perform each of the blocks of the algorithm in the aforementioned flowcharts of FIGS. 13, 14, 15, and 16. As such, each block in the aforementioned flowcharts of FIGS. 13, 14, 15, and 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware components, represented by the processor 1704, the components 1732, 1734, 1736, 1738, 1740, 1742, and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus, e.g., in the BAN, over a wireless transmission medium. The transceiver 1710 receives a signal from the one or more antennas 1720, extracts information from the received signal, and provides the extracted information to the processing system 1714, specifically the reception component 1734. In addition, the transceiver 1710 receives information from the processing system 1714, specifically the transmission component 1734, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system 1714 further includes at least one of the components 1732, 1734, 1736, 1738, 1740, 1742. The components may be software components running in the processor 1704, resident/stored in the computer readable medium/memory 1706, one or more hardware components coupled to the processor 1704, or some combination thereof.

In one configuration, the apparatus 1702 for wireless communication may include means for establishing a connection with a leader as a follower in the BAN, means for refraining from transmitting until a transmission is received from the leader, means for receiving the transmission from the leader, means for transmitting a second transmission to the leader within the window of time, means for retransmitting the second transmission to the leader when an acknowledgement ACK is not received within a second window of time, means for receiving a request to enter a sleep mode from the leader, means for transmitting a response to the leader agreeing to enter the sleep mode, means for entering the sleep mode when a confirmation message is received from the leader, means for receiving a sleep confirmation message from the leader following the sleep duration, means for continuing in the sleep mode when there is no data for transmission from the follower, means for transmitting a data transmission in response to the sleep confirmation message when the data transmission is waiting for transmission from the follower, means for waking up prior to the end of the sleep duration to adjust for clock drift, means for receiving a first message indicating that the leader releases leadership of the BAN, means for transmitting a second message requesting to be established as a new leader of the BAN, means for receiving a confirmation message confirming the follower as the new leader of the BAN, means for performing carrier sensing and random access prior to transmitting the second message, means for closing a connection to the leader, means for receiving a second message from a different device requesting to be established as a new leader of the BAN, and/or means for establishing a connection with the different device as the new leader of the BAN.

In another configuration, the apparatus 1702 for wireless communication may include means for establishing a connection with at least one follower in the BAN, means for transmitting a transmission to the at least one follower, means for refraining from transmitting for a window of time following the transmission according to a leader-follower protocol, wherein the window of time corresponds to a transmission opportunity for the at least one follower, means for transmitting a request to enter a sleep mode to the follower, means for receiving a response to the leader agreeing to enter the sleep mode, means for transmitting a confirmation message, means for entering the sleep mode, means for transmitting a sleep confirmation message to the follower following the sleep duration when there is no data for transmission to the follower, means for transmitting a data transmission at the end of the sleep duration, when the data transmission is waiting for transmission to the follower, means for transmitting multiple repetitions of a sleep confirmation message surrounding an end of the sleep duration, means for transmitting a first message indicating that the leader releases leadership of the BAN, means for receiving a second message from the follower requesting to be established as a new leader of the BAN, means for transmitting a confirmation message confirming the follower as the new leader of the BAN, means for receiving data for transmission to a follower in the BAN, means for performing carrier sensing and random access, means for transmitting a second message requesting to be established as a new leader of the BAN, means for receiving messages from multiple followers requesting to be established as a new leader of the BAN, means for selecting one of the multiple followers as the new leader of the BAN, and/or means for transmitting a second message confirming the new leader of the BAN.

The aforementioned means may be one or more of the aforementioned components of the apparatus 1702 and/or the processing system 1714 of the apparatus 1702 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a follower in a body area network (BAN), comprising:
establishing a connection with a leader in the BAN; and
refraining from transmitting until a transmission is received from the leader, wherein the transmission received from the leader triggers a transmission opportunity at the follower for a window of time.

2. The method of claim 1, further comprising:
receiving the transmission from the leader; and
transmitting a second transmission to the leader within the window of time.

3. The method of claim 2, wherein the transmission from the leader comprises at least one of a data transmission, a poll transmission, an acknowledgement (ACK), and a sleep mode message.

4. The method of claim 2, wherein the second transmission comprises:
an ACK to the transmission from the leader when there is no data for transmission from the follower; and
the ACK to the transmission from the leader multiplexed with a data transmission when the data transmission is waiting for transmission from the follower.

5. The method of claim 2, further comprising:
retransmitting the second transmission to the leader when an acknowledgement (ACK) is not received within a second window of time, wherein the second window of time is shorter than the window of time.

6. The method of claim 1, wherein the follower is limited to transmitting a single frame during the transmission opportunity.

7. The method of claim 1, wherein the follower is limited to transmitting a number of multiple frames during the transmission opportunity that can be received by the leader during the window of time.

8. The method of claim 1, further comprising:
receiving a request to enter a sleep mode from the leader;
transmitting a response to the leader agreeing to enter the sleep mode; and
entering the sleep mode when a confirmation message is received from the leader.

9. The method of claim 8, wherein the request to enter the sleep mode comprises an indication of a sleep duration, wherein the follower enters the sleep mode for the sleep duration.

10. The method of claim 9, further comprising:
receiving a sleep confirmation message from the leader following the sleep duration;
continuing in the sleep mode when there is no data for transmission from the follower; and
transmitting a data transmission in response to the sleep confirmation message when the data transmission is waiting for transmission from the follower.

11. The method of claim 10, wherein the sleep confirmation message comprises a preamble that the follower uses to calibrate a clock at the follower.

12. The method of claim 9, further comprising:
waking up prior to an end of the sleep duration to adjust for clock drift.

13. The method of claim 1, further comprising:
receiving a first message indicating that the leader releases leadership of the BAN;
transmitting a second message requesting to be established as a new leader of the BAN; and
receiving a confirmation message confirming the follower as the new leader of the BAN.

14. The method of claim 13, further comprising:
performing carrier sensing and random access prior to transmitting the second message.

15. The method of claim 1, further comprising:
receiving a first message indicating that the leader releases leadership of the BAN;
closing the connection to the leader;
receiving a second message from a different device requesting to be established as a new leader of the BAN; and
establishing a second connection with the different device as the new leader of the BAN.

16. An apparatus for wireless communication at a follower in a body area network (BAN), comprising:
a memory; and
at least one processor coupled to the memory and configured to:
establish a connection with a leader in the BAN; and
refrain from transmitting until a transmission is received from the leader, wherein the transmission received from the leader triggers a transmission opportunity at the follower for a window of time.

17. A method of wireless communication at a leader in a body area network (BAN), comprising:
establishing a connection with at least one follower in the BAN;
transmitting a transmission to the at least one follower; and
refraining from transmitting for a window of time following the transmission according to a leader-follower protocol, wherein the window of time corresponds to a transmission opportunity for the at least one follower.

18. The method of claim 17, wherein the transmission comprises at least one of a data transmission, a poll transmission, an acknowledgement (ACK), and a sleep mode message.

19. The method of claim 17, wherein the transmission comprises a poll transmission that is transmitted when the leader does not have data for transmission to the at least one follower for a threshold period of time.

20. The method of claim 17, wherein the leader establishes connections with multiple followers in the BAN, wherein the leader communicates with each of the multiple followers based on the leader-follower protocol.

21. The method of claim 20, wherein the leader communicates with each of the multiple followers based on point-to-point communication between the leader and the corresponding follower.

22. The method of claim 17, further comprising:
transmitting a request to enter a sleep mode to the at least one follower;
receiving a response to the leader agreeing to enter the sleep mode;
transmitting a confirmation message; and
entering the sleep mode.

23. The method of claim 22, wherein the request to enter the sleep mode comprises an indication of a sleep duration, wherein the leader enters the sleep mode for the sleep duration.

24. The method of claim 23, further comprising:
transmitting a sleep confirmation message to the at least one follower following the sleep duration when there is no data for transmission to the at least one follower; and
transmitting a data transmission at the end of the sleep duration, when the data transmission is waiting for transmission to the at least one follower.

25. The method of claim 24, wherein the sleep confirmation message comprises a preamble for clock calibration at the at least one follower.

26. The method of claim 23, further comprising:
transmitting multiple repetitions of a sleep confirmation message surrounding an end of the sleep duration.

27. The method of claim 17, further comprising:
transmitting a first message indicating that the leader releases leadership of the BAN;
receiving a second message from the at least one follower requesting to be established as a new leader of the BAN; and
transmitting a confirmation message confirming the new leader of the BAN.

28. The method of claim 17, further comprising:
transmitting a first message indicating that the leader releases leadership of the BAN;
receiving data for transmission to the at least one follower in the BAN;
performing carrier sensing and random access; and
transmitting a second message requesting to be established as a new leader of the BAN.

29. The method of claim 17, further comprising:
transmitting a first message indicating a release of leadership of the BAN;
receiving messages from multiple followers requesting to be established as a new leader of the BAN;
selecting one of the multiple followers as the new leader of the BAN; and
transmitting a second message confirming the new leader of the BAN.

30. An apparatus for wireless communication at a leader in a body area network (BAN), comprising:
a memory; and
at least one processor coupled to the memory and configured to:
establish a connection with at least one follower in the BAN;
transmit a transmission to the at least one follower; and
refrain from transmitting for a window of time following the transmission according to a leader-follower protocol, wherein the window of time corresponds to a transmission opportunity for the at least one follower.
